(19) United States
(12) Patent Application Publication
(10) Pub. No.: US 2002/0019932 A1
(43) Pub. Date: Feb. 14, 2002

(54) Cryptographically secure network

(76) Inventors: Eng-Whatt Toh, Singapore (SG); Mark E. Kitson, Singapore (SG); Kok-Hoon Teo, Singapore (SG); Chee-Hong Wong, Singapore (SG); See-Wai Yip, Singapore (SG)

Correspondence Address: FENWICK & WEST LLP, TWO PALO ALTO SQUARE, PALO ALTO, CA, 94306, US

(21) Appl. No.: 09/978,113

(22) Filed: Oct. 15, 2001

Related U.S. Application Data
(63) Continuation-in-part of application No. 09/881,899, filed on Jun. 14, 2001.
(63) Continuation-in-part of application No. 09/332,358, filed on Jun. 10, 1999.
(63) Continuation-in-part of application No. 09/887,157, filed on Jun. 21, 2001.
(60) Provisional application No. 60/242,015, filed on Oct. 19, 2000.

(51) Int. Cl. H04L 9/00

(52) U.S. Cl. 713/155; 380/257

(57) ABSTRACT

Systems, methods, and computer-readable medium for securely transmitting data (400) between at least two access systems (300, 320) via a switch system (310). Through the use encryption keys and the switch system (310) acting a central switch, any two access systems are able to securely transmit data (400) between them. The present invention can be implemented by means of an application proxy (1000), a secure connection enabled application, or application program interfaces.

### BACKGROUND OF THE INVENTION

1. Field of the Invention

This invention relates generally to secure transmission of data. More particularly, the invention relates to computer-implemented systems and techniques for securely transmitting data from a sender to a recipient.

2. Description of Background Art

The Internet is becoming, if it has not already become, required infrastructure for business. Businesses are connected to the Internet for critical functions such as e-mail, Internet access, procurement, online exchanges, and e-commerce. However, the Internet suffers from reliability and security problems.

The Internet represents the internetworking of multiple computer systems. These interconnected computer systems allow for the rapid transfer of data between and among different parties. Although the Internet facilitates communications between networked parties, it does not provide transactional guarantees or adequate security. A hacker anywhere in the world can remotely hack into almost any online system. These security vulnerabilities create concerns for people or organizations wanting to utilize the benefits of the Internet.

One response to the security problems of Internet has been the deployment of virtual private networks (“VPN”). A VPN provides authentication for access, typically provides direct connections between user and system to ensure transactions are kept within the network, and optionally provides event tracking for audit trail.

The typical deployment and implementation of a VPN is depicted in FIG. 1. VPN gateways 101, 121 are deployed at both ends of a transmission link 111. The VPN gateways encrypt and decrypt data transmissions entering into or arriving from the unsecured Internet 110 in order to provide security and privacy to the data transmissions. Dial-in adaptors are provided on mobile desktops 130 to provide encryption and decryption for mobile users who need to connect to one of these gateways 101, 121.

FIG. 2 depicts the seven layers 201-207 of the Open Systems Interconnection (“OSI”) model. Current VPN architectures are typically implemented as a layer two 202 or layer three 203 service in the OSI network model. Examples of Layer 2 protocols include the Layer 2 Tunneling Protocol (“L2TP”) and the Point-to-Point Tunneling Protocol (“PPTP”). Alternately, the VPN connection could be established using an OSI layer 3 protocol such as IP Security protocol (“IPSEC”). Because of the layer 2 or layer 3 implementation of VPNs, all application network traffic is subject to the same VPN policies. Typically the VPN policy is to encrypt/decrypt all network transmission based on Internet Protocol (“IP”) destinations. For example, in FIG. 1, VPN gateway 101 at network A 100 will encrypt/decrypt all network traffic sent to or received from network B 120, and network B 120 will do likewise for all data transmission sent to or received from network A 100.

The prior art represents significant barriers to VPN adoption for business-to-business use. For example, as depicted in FIG. 1, the current VPN architecture requires infrastructure, such as VPN gateways 101, 121; and protection is limited to these predefined links. The cost and effort required to install and maintain such systems makes it suitable only for high volume links, thus making it difficult to support general business transactions, many of which are with a changing group of partners and may not justify a dedicated VPN gateway. Furthermore, partners with existing VPN gateways may not be interoperable with the VPN gateways 101, 121.

Alternatively, a business may grant its partners VPN access to certain critical applications. However, this access compromises internal security because an outside entity (i.e. the partner) will consequently have access to the business' internal network. In addition, this approach requires partners to have multiple VPN adaptors on their desktops or within their networks in order to transact with different businesses. Because VPNs are implemented at layer 2 or 3, having multiple VPN adaptors co-exist on a single computer desktop may result in incompatibilities and network contention. This implementation makes it difficult for a user to access multiple application services that require separate VPNs as the adaptors would be extremely difficult to implement and manage.

In summary, to protect business communications, current VPN systems require all partners to have compatible VPN gateways, which is infeasible. Alternatively, a business can grant partners VPN access to internal business applications, but this would create internal security threats. Such architecture is also infeasible for the partners since they may have to contend with incompatible VPN adaptors.

What is needed is a secure network connection or VPN that is mutually interoperable with other secure connections to allow a business to securely transact with multiple partners across multiple secure connections. The secure connection preferably is dynamic such that any two users or applications can utilize the secure connection, not just those on pre-selected VPN gateways. Finally, the secure network connection preferably is compatible with existing systems and should not cause incompatibilities. The above attributes ensure that businesses can easily and securely connect to each other without each business having to deploy their own VPN gateways to all their partners, significantly reducing the cost of VPN deployment.

### SUMMARY OF THE INVENTION

In accordance with the present invention, there are provided at least two access systems (300, 320) for securely transmitting data via a single node (310) or a multi-node switch system (1110). Each access system, whether sending data or receiving data, connects to the switch system (310, 1110) by forming a secure connection (431, 432). In this manner, a secure network (431, 432) is effectively created from the sending access system (300) to the receiving access system (320). Having a switch system (310, 1110) ensures interoperability since each access system (300, 320, 340, 1130-1150) need only be compatible with the switch system (310, 1110) and not anybody else.

In one embodiment, the present invention is implemented in a secure-connection enabled application to enable dynamic and rapid deployment. In an alternate embodiment, the present invention is implemented through application program interfaces (APIs). In yet another embodiment, the present invention is implemented using an application proxy (1000) or proxies. The application proxy can transparently direct certain data transmission, as defined by policies set by an operator of a network system (301) or set by the switch system (310), to utilize the present invention.

The secure connections of the present invention are established using private-public key pair encryption. Thus, data transmissions between access systems and the switch system are secured by encrypting the data with public-private encryption keys. The encryption of the data can be implemented at lower layers of the OSI model. Alternatively, the encryption can be implemented at one or more layers of the host subset layers (layers 5-7) of the OSI model. Implementing the encryption at the upper layers (205-207) reduces conflict problems with other VPN deployments within a network system.

### BRIEF DESCRIPTION OF THE DRAWINGS

FIG. 1 is a schematic representation of prior art VPN gateway (101, 121) deployment.

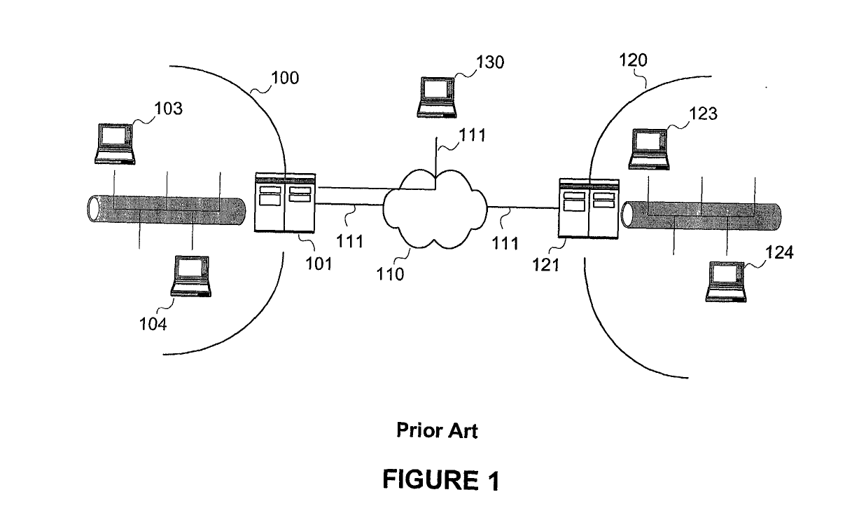

FIG. 2 is a depiction of the Open Systems Interconnections (“OSI”) Seven Layer model.

FIG. 3 is a schematic representation of a first access system (300), a mobile user access system (340) and a second access system (320) connected through an Internet connection (331 ) to a switch system (310).

FIG. 4 is a functional block diagram of an embodiment of the present invention.

FIG. 5 is a flow diagram of an embodiment of the present invention whereby data (400) is securely transmitted from a sending access system (300) to a receiving access system (320) via a switch system (310).

FIG. 6 is a flow diagram of an embodiment of the authentication process (510, 560).

FIG. 7 is a flow diagram of an embodiment of the process of establishing a secure network connection (520, 570).

FIG. 8 is a flow diagram of an alternate embodiment of the process of establishing a secure network connection.

FIG. 9 is a diagram depicting multiple applications (901-903), some with secure connection capabilities (901, 903) and at least one without such capabilities (902), co-existing within a network system.

FIG. 10 is a schematic representation of the present invention utilizing an application proxy (1000).

FIG. 11 is a schematic representation of the present invention wherein the switch system (1110) contains multiple nodes (310A-C).

### DETAILED DESCRIPTION OF THE PREFERRED EMBODIMENTS

Before turning to the embodiments of the present invention, it is instructive to review some principles of cryptography. Cryptographic algorithms can generally be divided into two classes: symmetric key cryptography and asymmetric key cryptography. The keys themselves are typically large numbers derived from complex mathematical algorithms. These keys are used to encrypt and/or decrypt a data file.

Symmetric key cryptography uses a single key to both encrypt and decrypt data. Data encrypted with a symmetric key can, for all practical purposes, be decrypted only by that same key. For example, if a sender encrypts data with a symmetric key and sends the encrypted data to a recipient, the recipient can decrypt the data only if he possesses the same key that the sender used to encrypt the data. One of the benefits of using symmetric keys is efficiency. The amount of computing (and therefore, the amount of time) necessary for encrypting and decrypting the data is less than that required for other encryption methods. Thus, the delay experienced by the sender and recipient during the encryption and decryption processes may be reduced.

Asymmetric key encryption, also called public-key encryption, involves a pair of keys—a public key and a private key. Once a user has generated a key pair, the user typically keeps the private key secret but publishes the corresponding public key. The public key and the private key are mathematically related so that one key can decrypt data encrypted by the other key. However, the mathematical relationship between the keys is sufficiently complex that it is computationally infeasible to derive one key given the other. Thus, if a sender wants to send data to a recipient in a manner such that only the recipient can read the data, the sender can encrypt the data with the recipient's public key. Since only the recipient's private key can decrypt the data, the sender can be assured that only the recipient can read the data, assuming that the recipient is the only one with access to his private key.

In addition to encrypting data so that only specific individuals can decrypt the data, public-key encryption can also be used for other important purposes. For example, public-key encryption allows the recipient of a document to verify the identity of the sender. Assuming that data is encrypted using the sender's private key, it can be decrypted only by the corresponding public key. If a recipient can decrypt data using a certain person's public key, he can be assured that the data was originally encrypted using the corresponding private key. Thus, the recipient can be assured that the certain person was the one sending the data. In other words, the sender has digitally signed the data.

However, for this identification to be effective, the recipient must receive the sender's public key in a manner in which the recipient trusts that the key is in fact the sender's public key and not someone else's public key. This trusted transmission of the sender's public key can occur in several ways. For example, the sender could personally give the public key to the recipient. Alternatively, the sender could deliver the public key via a trusted delivery service.

Another possible method is to link the sender to his public key by a digital certificate issued by a trusted third party. A digital certificate is a digital document that identifies a certain public key as belonging to, or is associated with, a certain entity, such as individuals, legal entities, Web servers, and the like, in a trustworthy manner. A trusted third party, known as a certificate authority or CA, typically issues a digital certificate. The CA issues a certificate that identifies, among other things, an entity and that entity's public key. In this manner, the CA acts like a notary, attesting that a certain key belongs to a certain entity. A recipient who trusts the CA can be assured that any data decrypted with that public key must have been encrypted with the corresponding private key, and if only the sender has access to that private key, the recipient knows that the sender sent the data.

A digital signature may be generated in other ways as well. For example, a sending system can digitally sign a hash or digest of a data file. A hash or digest of a data file is obtained by operating a hash algorithm on the data file. A hash algorithm is a method of transforming a variable length message, in this case the data file, into a fixed length number. This fixed length number is referred to as the hash or digest of the original data file. For this digest to be useful as part of a digital signature, the contents of the data file must not be practically ascertainable from the digest number. Thus, hash algorithms are one-way functions, which can easily generate a hash from a data file, but which cannot, for all practical purposes, generate the original data file given the hash. The digest's usefulness as a digital fingerprint of a data file also depends upon its ability to correlate uniquely to the original data file. Ideally, a hash algorithm is a strictly one to-one function so that each hash number can be generated by one, and only one, data file. Any change in the data file, no matter how insignificant, will generate a different hash number. If a hash algorithm generates the same hash for two different data files, a collision exists which could compromise the usefulness of the hash. Thus, one measure of a hash algorithm's usefulness is the frequency at which more than one data file will generate the same hash number. In practice, useful hash algorithms may generate collisions in theory but the probability is low enough as to be practically negligible. Well-known one-way hash algorithms that are useful for digital signing include MD2, MD5, and SHA-1.

The hash of the data file, along with information about the hash algorithm used to generate the hash, is then encrypted with the sender's private key. The sender transmits the original data file as well as the encrypted hash to the recipient. The recipient uses the sender's public key to decrypt the hash. To verify the integrity of data file, the recipient uses the same hash algorithm on the original data file. If the hash generated by the recipient does not match the decrypted hash, this indicates a problem. The digital signature may not have been created with the sender's private key or the data may have been tampered with since it was signed by the sender. If the hashes match, the recipient can be reasonably assured that the sender sent the data and that it has not been altered. For the following discussion of the present invention, references to digital signatures or digitally signing shall include all of the aforementioned variants of the digital signatures and digitally signing.

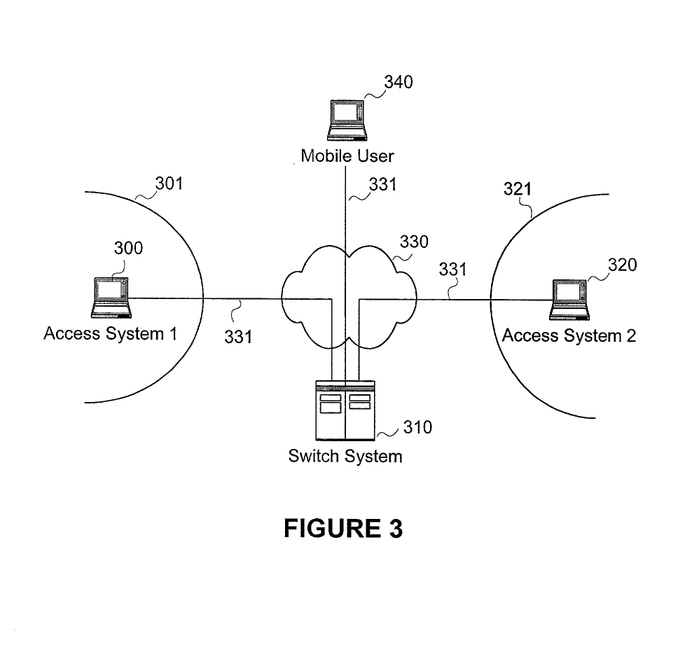

Referring to now FIG. 3, a diagram depicts an embodiment of the present invention. FIG. 3 illustrates a first access system 300, a second access system 320, and a switch system 310 interposed between the two access systems 300, 320. The switch system 310 can connect to each access system via network connections 331, for example, via connections to the Internet network 330. The access systems 300, 320 are depicted as being part of separate entity 301, 321 (respectively), such as separate businesses. Either or both access systems 300, 320 could represent a single computer within a local area network at the entities; or the access systems 300, 320 could represent the access system for the entire entity 301, 321. Thus, there may be multiple access systems within an entity or just one access system for all users within the entity. The present invention can also be utilized by a mobile user 340. For example, the mobile user 340 can be an employee of one of the entities 301, 321 who is working outside of the office. The present invention allows the mobile user 340 to securely transact with its offices 301 or 321.

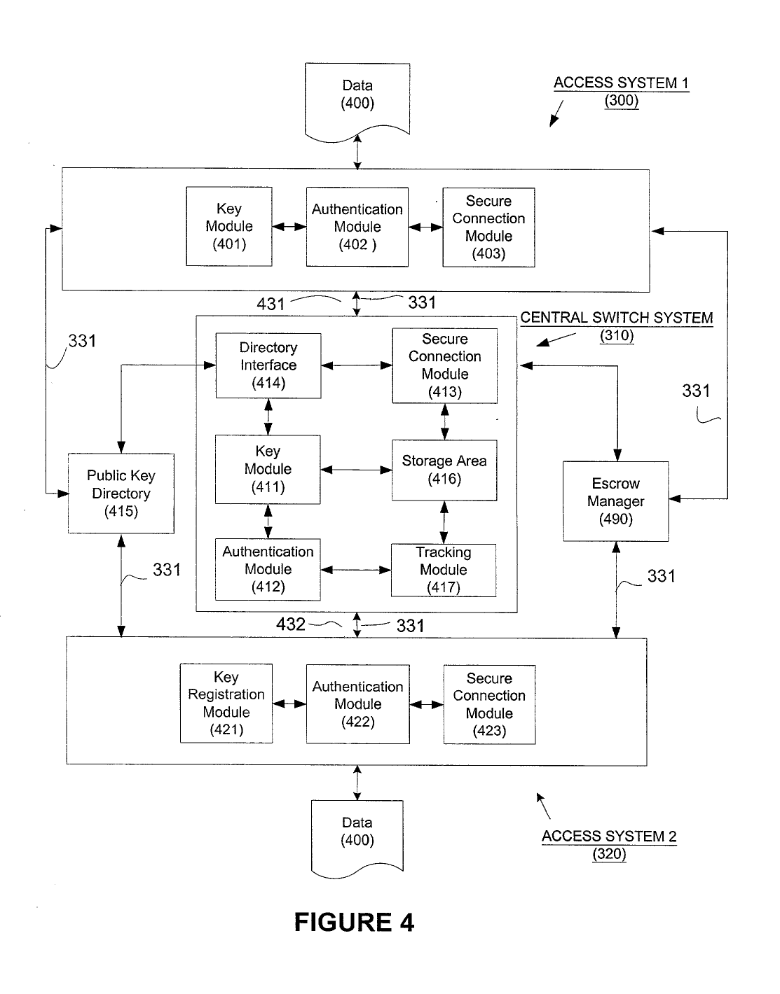

Referring now to FIG. 4, a block diagram depicts an embodiment of the present invention. FIG. 4 illustrates functional components of the first access system 300, the second access system 320, and the switch system 310. Providing a switch system 310 between the access systems 300, 320 solves the interoperability problem because each access system 300, 320 need only be compatible with the switch system 310 to be able to communicate with any other access systems.

The first access system 300 comprises a key module 401, an authentication module 402, and a secure connection module 403. Each of the modules is communicatively interconnected with the other modules as needed. Each module could be implemented in software, hardware, firmware, or some combination of software, hardware, and/or firmware. To enable dynamic and rapid deployment, these modules could be implemented in a single application or split between more than one application, implemented by an application proxy, or implemented through application program interfaces (APIs). The implementation of the different embodiments, such as application proxies and APIs, will be discussed in more detail below.

The second access system 320 similarly comprises a key module 421, an authentication module 422, and a secure connection module 423. Each of the modules is communicatively interconnected with the other modules as needed. Each module could be implemented in software, hardware, firmware, or some combination of software, hardware, and/or firmware. As with the first access system, these modules could be implemented in a single application or split between more than one application, implemented by an application proxy, or implemented through application program interfaces (APIs). As mentioned above, the implementation of the different embodiments, such as application proxies and APIs, will be discussed in more detail below.

In the present embodiment, the modules in the first and second access system 300, 320 (respectively) are functionally equivalent. Throughout the description, a reference to a module in one access system should be understood to apply to the corresponding module in the other access system.

Using access system 300 as an example, the key module 401 stores or otherwise accesses a private-public key pair of the user of an access system. The key module 401 can also be configured to store or access multiple key pairs of a single or of multiple users. For example, the key module 401 could require a user to login. A password-protected login could identify which user is utilizing the access system 300 and thus indicates to the key module 401 which key pair should be used. Alternately, the access system 300 could use only one key pair for a group of users. In each of the embodiments, the key module 401 accesses the key pair for use in the present invention.

For each of the embodiments, the key module 401 can also provide the switch system 310 with the public key or certificate of the user, which the switch system then associates with the user of the access system 300. It shall be understood that references to “user” shall be read to include both single users and groups of users and that references to a user's private-public key pair is synonymous with references to an access system's private-public key pair. To utilize the present invention, the user of an access system 300 possesses a private-public key pair and must provide the switch system 310 with access to the public key. The user of the access system 300 can obtain a key pair by generating a key pair, or have a key pair generated for it by a trusted third party, such as the switch system 310. The key module 401 can include the ability to generate a key pair or facilitate the generation of a key pair for the user.

Once a key pair has been obtained, the key module 401 makes the public key available to the switch system 310. The key module 401 can make the public key available to the switch system 310 by sending the public key or a digital certificate to the switch system 310 or publishing the key or the certificate to a generally accessible public key database or directory 415. The key should be transmitted to the switch system in such a way that the switch system 310 can be assured that the public key belongs to the user. Using a digital certificate is an effective way to achieve this result. Alternatively, the switch system 310 could generate the key pair and transmit the private key to the access system 300. However, it is preferred that the private key be kept private, that is, not known to anyone but the key pair owner. It is also preferred that the private key not be transmitted lest it be intercepted by a third party. Another alternative would be to verify that the public key is the user's key by using a shared secret, something only the user and the switch system 310 know. After the switch system 310 has associated the public key with the user at the access system 300, the user can utilize the present invention to securely transmit data 400 via the switch system 310.

Connected to the key module 401 in the access systems 300 is an authentication module 402. The authentication module 402 authenticates the user to the switch system 310 using the user's private-public key pair. The authentication module 402 can also be adapted to authenticate the identity of the switch system 310 to the access system 300 by using a switch system public key, in conjunction with the switch system 310 using its corresponding switch system private key.

Connected to the key module 401 and the authentication module 402 is a secure connection module 403 for establishing a cryptographically secure network connection between the switch system 310 and the access system 300. The secure connection module 403 transmits data 400 to and/or receives data 400 from the switch system 310 via a cryptographically secure network connection 431.

The switch system 310 contains a key module 411, an authentication module 412, a secure connection module 413, and a storage area/computer readable medium 416. The switch system 310 can also contain a directory interface 414, public key directory/database 415, a tracking module 417, and an escrow manager 490.

The key module 411 is for associating each user of an access system with a public key from the user's private-public key pair. Alternatively, the key module 411 could store, edit, and retrieve users' public keys/certificates from a public key directory/database 415 of public keys/certificates. In one embodiment, the public key and/or certificate directory 415 is implemented using an existing directory infrastructure provided, for example, by VeriSign, Inc. of Mountain View, Calif. In alternate embodiments, the public key/certificate directory 415 is implemented using a conventional database system, such as one available from SyBase, Inc. of Emeryville, Calif. In the prior example, the directory 415 may be accessible by the general public, including each of the access systems 300, 320 via a network connection 331. In the latter example, the directory 415 may be accessed only by the switch system 310. Preferably, the public key/certificate directory 415 is accessed by a directory interface 414 (not shown for the access systems) using the Lightweight Directory Access Protocol (“LDAP”) and is searchable by one or more fields, such as user name, user email address, user telephone number, company name, company telephone number, and/or account number. Regardless of implementation of the directory service, the switch system 310 uses the public keys obtained from the directory 415 to authenticate the access system 300, 320 and to establish the secure connections 431, 432 between the access systems 300, 320.

Connected to the key module 411 is an authentication module 412. The authentication module 412 authenticates the user to the switch system 310 using the user's private-public key pair. The authentication module 412 can also be adapted to authenticate the identity of the switch system 310 to the access system 300, 320 by using the switch system private-public key pair.

Connected to the key module 411 and the authentication module 412 is a secure connection module 413 for establishing a cryptographically secure network connection between the switch system 310 and the access systems 300, 320. The secure connection module 413 receives the data 400 from one access system 300 and transmits the data 400 to the intended recipient access system 320.

Connected to the other modules is a storage area 416, such as a computer-readable medium, used by the switch system 310. The storage area 416 could be used for short-term storage needed for performing operations, such as encryption and decryption. The storage area 416 could also be used for storing items for longer periods. For example, if the switch system 310 receives data 400 intended for the second access system 320, the switch system 310 can store the data 400 in the storage area 416 until the second access system 320 securely connects to the switch system 310 to receive the data 400.

The switch system 310 can also optionally include a transaction module for tracking and notification. Tracking features are implemented by the tracking module 417 and include, for example, tracking and time-stamping the data transmission at main points throughout the delivery process. For example, when the sending access system 300 transmits the data 400 to the switch system 310, the tracking module 417 assigns a unique tracking number to the data transmission transaction and then tracks the data transmission throughout the main points of the delivery process. Examples of main points through the delivery process could include, among others, the time at which the data 400 was transmitted to the switch system 310 and the time at which the switch system transmitted the data to the receiving access system 320.

The modules in the switch system are interconnected. The connections between modules within the access systems 300, 320 and between the modules within the switch system 310 as described in the written description and as depicted in FIG. 4 are representative of the interconnections. It shall be understood that the modules within each of the systems 300, 310, 320 are communicatively connected as needed to practice the present invention.

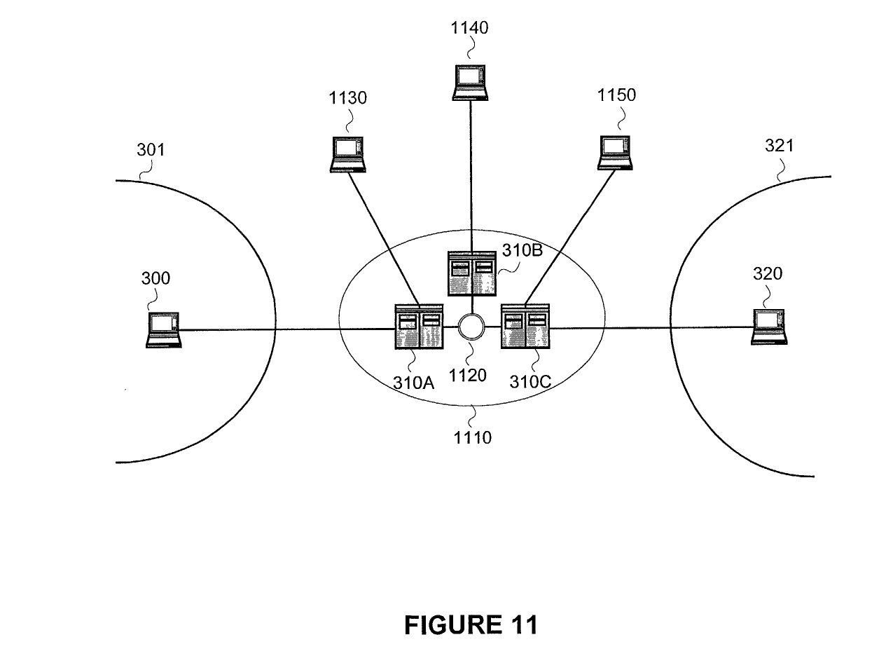

Each module could be implemented in software, hardware, firmware, or some combination of software, hardware, and/or firmware. These modules could be implemented in a single node switch system or a multi-node switch system, as will be discussed in more detail below in reference to FIG. 11.

The present invention could also include an escrow manager 490 connected 331 to the access systems 300, 320 and also connected to the switch system 310. As described in more detail below, the escrow manager 490 can provide an escrow key to enhance security of the cryptographically secure network.

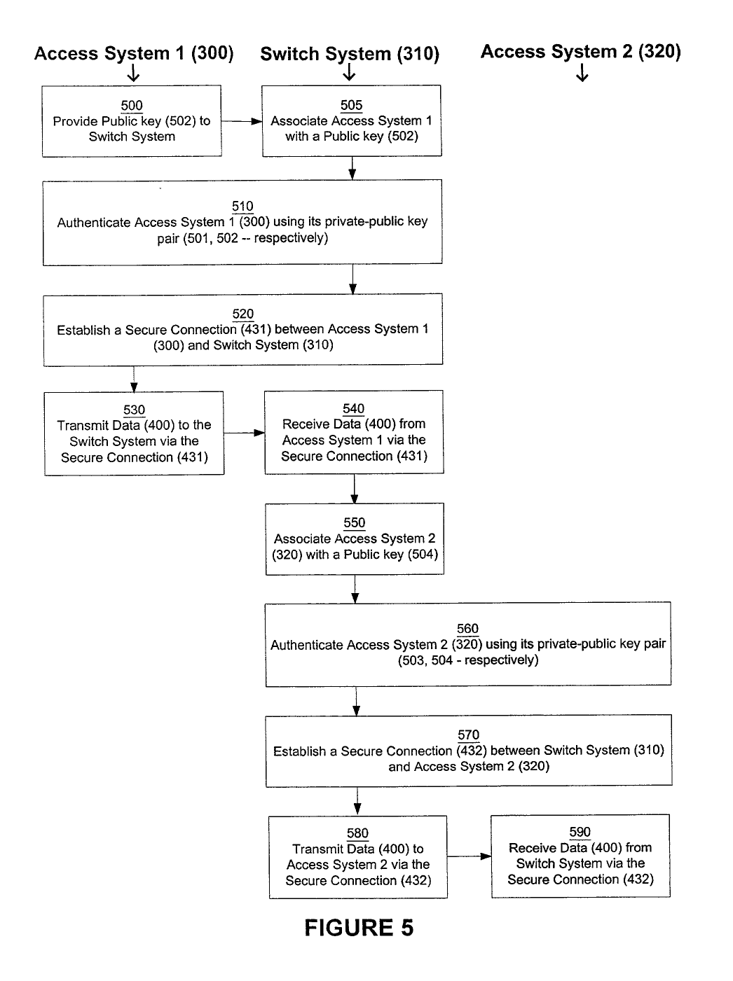

FIG. 4 depicts the functional components of the access and switch systems. FIG. 5 depicts an embodiment of the process of the present invention as performed by the access systems and switch system.

A user at the first access system 300 wishes to securely transmit data 400 to another user at a second access system 320. To begin, the user has a private-public key pair 501, 502 (respectively), and as mentioned above, the user provides 500 the public key 502 to the switch system 310. The switch system 310 associates 505 that public key 502 as belonging to that specific user. So long as the user's key pair remains valid and usable, steps 500 and 505 need not be repeated for the user to utilize the present invention to securely receive or to securely transmit data via the switch system 310.

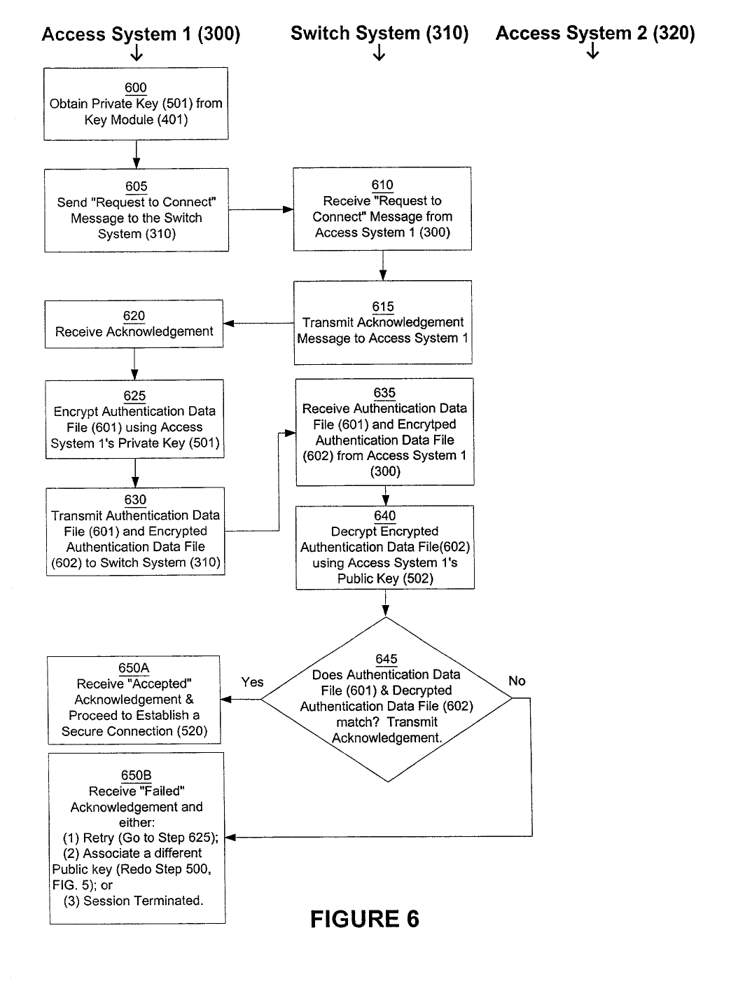

With the public key 502 associated 505 with the user, the first access system 300 and the switch system 310 use the user's private-public key pair 501, 502 (respectively) to authenticate 510 the user's identity to the switch system. The authentication process is described in more detail below in reference to FIG. 6. The present invention can also include authenticating (not shown) the switch system to the first access system.

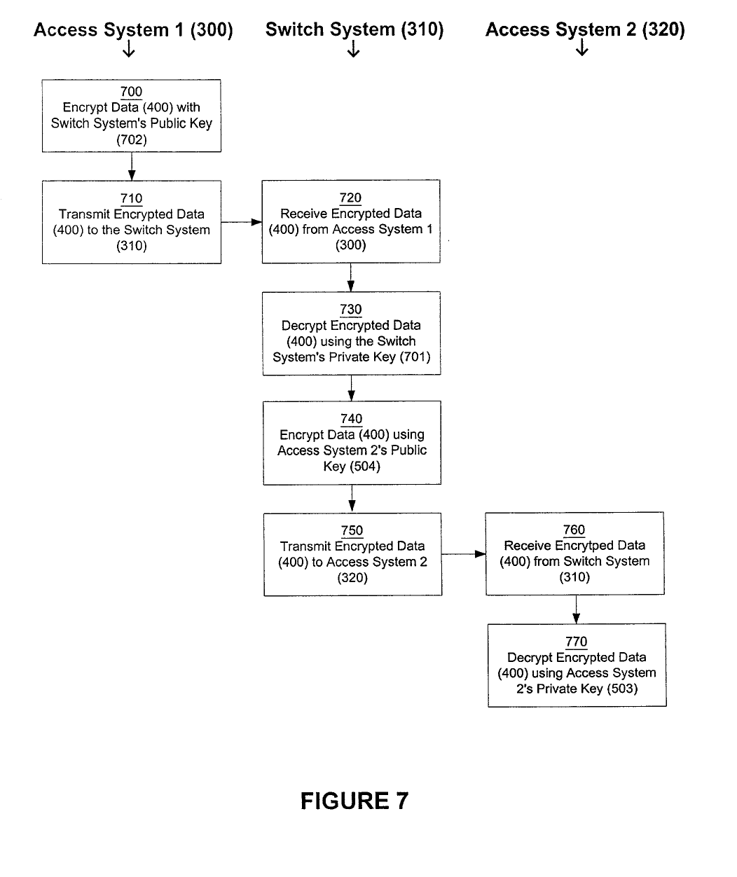

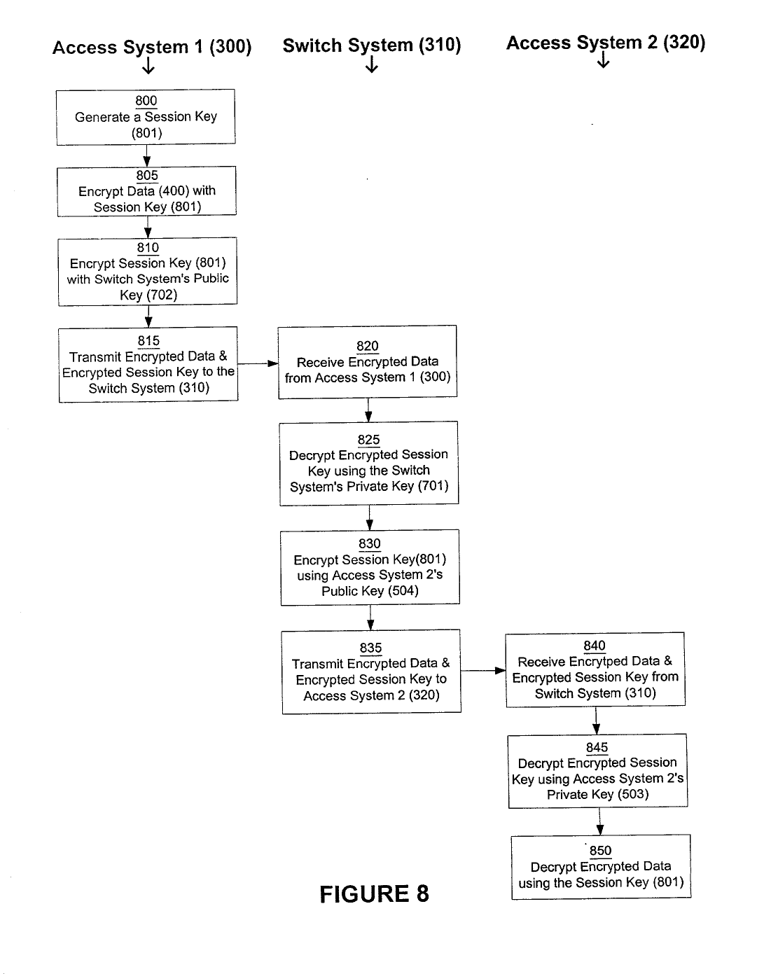

Following successful authentication, the first access system 300 and switch system 310 establish 520 a cryptographically secure network connection between the two systems 300, 310. The cryptographically secure network connection is described in more detail below in reference to FIGS. 7 and 8.

Having established 520 a cryptographically secure network connection 431, the first access system 300 transmits 530 the data 400 to the switch system 310 via the secure connection 431. The switch system 310 receives 540 the data 400. The switch system 310 can store (not shown) the data 400 until the recipient, the user at the second access system 320, retrieves it.

In order to retrieve the data, the second access system 320 also has a private-public key pair 503, 504 (respectively), and as with the first access system, the second access system user provides its public key 504 to the switch system 310 so that the switch system 310 can associate 550 the public key 504 with the second user. This process, step 550, can occur at any time prior to step 560, even prior to step 500 and need not be repeated after that as long as the keys 503, 504 are still valid.

With the public key 504 associated 550 with the second user, the second access system 320 and the switch system 310 use the second user's private-public key pair 503, 504 (respectively) to authenticate 560 the second user's identity to the switch system 310. The authentication process is similar to that which is described below with reference to the authentication of the first user in FIG. 6. The present invention can also include authenticating (not shown) the switch system to the second access system.

Following successful authentication, the second access system 320 and switch system 310 establish 570 a cryptographically secure network connection 432 between the two systems 310, 320. Establishing the cryptographically secure network connection 432 is similar to the process utilized by the first access system 300 and the switch system 310 as described below in reference to FIGS. 7 and 8.

Having established 570 a cryptographically secure network connection 432, the switch system 310 transmits 580 the data 400 to the second access system 320 via the secure connection 432. The second access system 320 receives 590 the data 400.

Referring now to FIG. 6, a flow chart depicts one embodiment of an authentication process wherein the authentication module 402 establishes the first access system's identity to the switch system 310. The authentication module 402 begins the authentication process by obtaining 600 the user's private key 501 from the key module 401. The authentication module 402 makes 605 a request to connect to the switch system 310. The switch system 310 receives 610 the request and returns 615 an acknowledgement. The authentication module receives 620 the acknowledgement and continues the authentication process.

The authentication module encrypts 625 an authentication data file 601, which could be random data or meaningful data, using the user's private key 501 to create an encrypted authentication data file 602. The authentication data file 601 and the encrypted authentication data file 602 are then transmitted 630 to the switch system 310. The switch system's authentication module 412 receives 635 the authentication file 601 and the encrypted authentication data file 602. The switch system's key module 411 obtains the user's corresponding public key 502. Once the corresponding public key 502 is obtained and returned to the authentication module 412, the authentication module verifies the digital signature by decrypting 640 the encrypted authentication file 602 using the user's public key 502. The decrypted authentication file is compared 645 with the authentication file 601. If the files match, the switch system 310 returns 650A an acknowledgement that the authentication was successful and that the systems can proceed to establish a secure connection (step 520, FIG. 5). If the files do not match, the switch system 310 returns 650B an acknowledgement that the authentication failed. As a result of the failed authentication, the access system or switch system could prompt the user to either: (1) retry the authentication process (by starting over at step 625); (2) provide the switch system with a different public key from a different private-public key pair (redo steps 500 and 505, FIG. 5); and/or (3) terminate the session.

The authentication process depicted in FIG. 6 is only one of many possible methods by which to authenticate the user to the switch system. Another method could involve providing a digitally signed file as part of the initial request (step 605) to the switch system. In yet another alternate method, the switch system could authenticate the user by requiring the user to successfully decrypt an authentication data file encrypted by the switch system using the user's public key 502. In yet another embodiment, the authentication data file 601 could be hashed and the hash digitally signed. In each embodiment, the user's private-public key pair is employed to verify that the access system is in possession of the private key which corresponds to the public key that the switch system associates with that user.

The authentication process can also include authenticating the switch system 310 to the access system. Such an authentication process can occur in like manner as described above with the exception that the switch system's private-public key pair is employed to verify the identity of the switch system to the access system.

After the authentication process has successfully completed, the secure connection modules 403, 413 in the access system and the switch system (respectively) establish a cryptographically secure network connection between the systems 300, 310. The secure connection can be established in a number of ways.

FIG. 7 depicts an embodiment for establishing a cryptographically secure network connection. The data 400 which the user at the first access system 300 wishes to securely transmit to the user at the second access system 320 is encrypted 700 with the switch system's public key 702. All data transmitted 710 to the switch system 310 from the first access system 300 is encrypted with the switch system's public key, and by so doing, effectively only the switch system can decrypt it.

The switch system 310 receives 720 the data 400 and decrypts 730 the data 400 using the switch system's private key 701. The switch system 310 re-encrypts 740 the data 400 with the public key 504 of the intended recipient, in this case, the user at the second access system 320. The re-encrypted data is transmitted 750 to the second access system 320. The second access system 320 receives 760 the data and decrypts 770 the data using the second access system's user's private key 503. Thus, the data 400 was securely transmitted from the first access system 300 to the second access system 320 via the switch system 310.

Alternatively, the data 400 which the user at the first access system 300 wishes to securely transmit to the user at the second access system 320 is encrypted with the second access system's public key 504. The encrypted data is transmitted 710 to the switch system 310 from the first access system 300. The switch system 310 receives 720 the data 400. The data is retransmitted 750 to the second access system 320 without change. The second access system 320 receives 760 the data and decrypts 770 the data using the second access system's user's private key 503. Thus, the data was securely transmitted from the first access system 300 to the second access system 320 via the switch system 310. In this embodiment, steps 730 and 740 are unnecessary.

Alternatively, the cryptographically secure connection can be established in other ways, such as the method depicted in FIG. 8, which involves the use of a session key 801. An embodiment of this method commences with the generation 800 of a session key 801 by the first access system 300. The first access system 300 encrypts 805 the data 400 using the session key 801 and encrypts 810 the session key 801 using the switch system's public key 702. Having encrypted both the data and the session key, the first access system 300 can securely transmit 815 those items to the switch system 310. After the switch system 310 has received 820 the encrypted data and encrypted session key, the switch system decrypts 825 the session key using the switch system's private key 701. The switch system then re-encrypts 830 the session key 801 with the public key 504 of the intended recipient, in this case, the user at the second access system 320. The re-encrypted session key and the encrypted data are transmitted 835 to the second access system 320. The second access system 320 receives 840 these items and decrypts 845 the session key 801 using the second access system's user's private key 503. By use of the decrypted session key 801, the data 400 can be decrypted into its original format. Thus, the data was securely transmitted from the first access system 300 to the second access system 320 via the switch system 310.

It shall be noted that FIG. 8 depicts the session key being generated 800 by the first access system 300. Alternatively, the session key 801 could be generated by the switch system 310 and sent to the first access system 300.

In yet another embodiment the data 400 could also be encrypted with a key that provides complete end-to-end encryption, in addition to point-to-point encryption. For example, the first access system 300 could obtain the recipient user's public key and encrypt the data 400 using that key. The first access system 300 could obtain the recipient user's public key by searching the public key database 415 or by requesting it from the switch system 310. This added encryption ensures that no one except the sending and receiving access systems 300, 320 can intelligibly comprehend the data. The use of the recipient user's public key can be added to any of the above embodiments. For example, the recipient user's public key could be used in place of the session key 801 or in addition to it.

In the cases in which the sending access system 300 cannot locate a public key to provide end-to-end encryption, the sending access system 300 could utilize an escrow key (not shown). For example, the escrow manager 490 could provide the access system 300 with an escrow encryption key. The escrow encryption key could be used to encrypt a session key 801 or the data 400. When the receiving access system 320 receives the encrypted data 400 from the switch system 310, the receiving access system can obtain the necessary escrow decryption key from the escrow manager 490. For added security, the receiving access system 320 could provide the escrow manager with its public key 504. The escrow manager 490 could then encrypt the escrow decryption key with the public key 504 and transmit it directly to the receiving access system 320 or could transmit it via the switch system 310.

For examples of key escrow systems, see commonly-assigned U.S. patent application Ser. No. 09/881,899, “Fast Escrow Delivery,” by Chee-Hong Wong, Kok-Hoon Teo, See-Wai Yip, Kok-Khuan Fong, and Eng-Whatt Toh, filed Jun. 14, 2001; commonly-assigned U.S. patent application Ser. No. 09/332,358, “Simplified Addressing for Private Communications,” by Eng-Whatt Toh and Peng-Toh Sim, filed Jun. 10, 1999; and commonly-assigned U.S. patent application Ser. No. 09/887,157, “Secure and Reliable Data Delivery,” by Eng-Whatt Toh, Chee-Hong Wong, Kok-Hoon Teo, and See-Wai Yip, filed Jun. 21, 2001. As stated previously, the subject matters of the foregoing applications are incorporated herein by reference in their entireties.

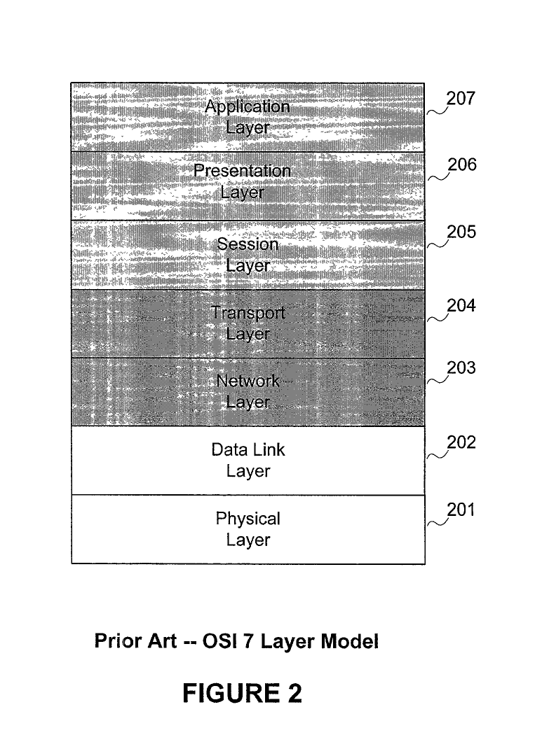

In any of the above embodiments, the present invention could utilize the encryption keys in protocols designed for layer 2 of the Open Systems Interconnection (“OSI”) network architecture model, such as the Layer 2 Tunneling Protocol (“L2TP”) or Point-to-Point Tunneling Protocol (“PPTP”). Alternately, the secure connections 431, 432 could be established using an OSI layer 3 protocol such as IP Security protocol (“IPSEC”). In yet another embodiment, the secure connections 431, 432 could be established at one of the layers in the host process subset (205, 206, 207 of FIG. 2), layers 5 through 7 of the OSI network architecture model.

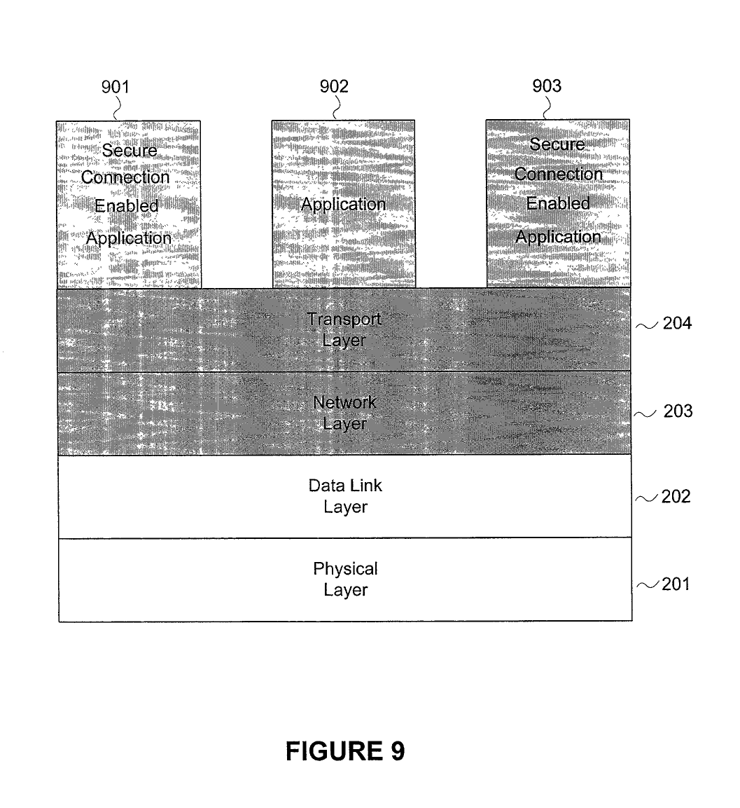

One benefit of establishing secure connections 431, 432 at the host process subset layers is that present VPN systems employ protocols in layers 2 and 3. If the sender's access system is part of a network that already utilizes a VPN, a conflict may be created between the existing VPN and the secure connections 431, 432 attempting to be established. By creating secure connections 431, 432 at the host process subset layers, an access system and the switch system 310 can establish a secure connection 431 or 432 independent of other VPN or network software used by the access system's network. As illustrated in FIG. 9, the secure network connection capabilities are built into applications. Thus, multiple applications, some with secure connection capabilities 901, 903 and some without secure connection capabilities 902, can all share network resources without contention or conflicts at the lower network layers.

In one embodiment, the secure connections 431, 432 are created at the application level by using a session key and directly transmit the data using, for example, Hypertext Transfer Protocol (“HTTP”), Transmission Control Protocol (“TCP”), or File Transfer Protocol (“FTP”). The secure connection modules 403, 423 and 413 establish the secure connection by performing the following functions. Either the access system's module 403, 423 or the switch system's module 413 generates a session key. Once a session key has been generated, the key-generating party transmits it via the network connection 331 to the other party by encrypting the session key with the receiving party's public key. For example, the sending access system's secure connection module 403 generates a session key and encrypts it with the switch system's public key 702. The encrypted session key is transmitted to the switch system's secure connection module 413, which decrypts the session key. Once both parties have the session key, they communicate via a secure connection 431 because all data transmissions are encrypted with the session key. This process allows a compatible secure connection to be created regardless of any existing VPN setup in the access system.

Although the foregoing discussion of the present invention was in reference to the embodiment depicted in FIG. 3, the foregoing discussion also applies to alternate embodiments. The present invention could be implemented using a personal computer, such as an I.B.M.-compatible computer or an Apple computer, or it could be implemented using a workstation, for example a Sun Microsystems workstation. Alternatively, the algorithm could be implemented by another application through application program interfaces (APIs). In such a case, the present invention functionality is incorporated into or is utilized by the other application. In yet another embodiment, the present invention could be implemented by an application proxy.

This application proxy could be implemented in software, hardware, firmware, or some combination of each. For example, the application proxy could be a software application operating on a server, or could be implemented as part of an edge router, access server, or firewall. The descriptions of the present invention shall be deemed to include any and all of these configurations and combinations of configurations.

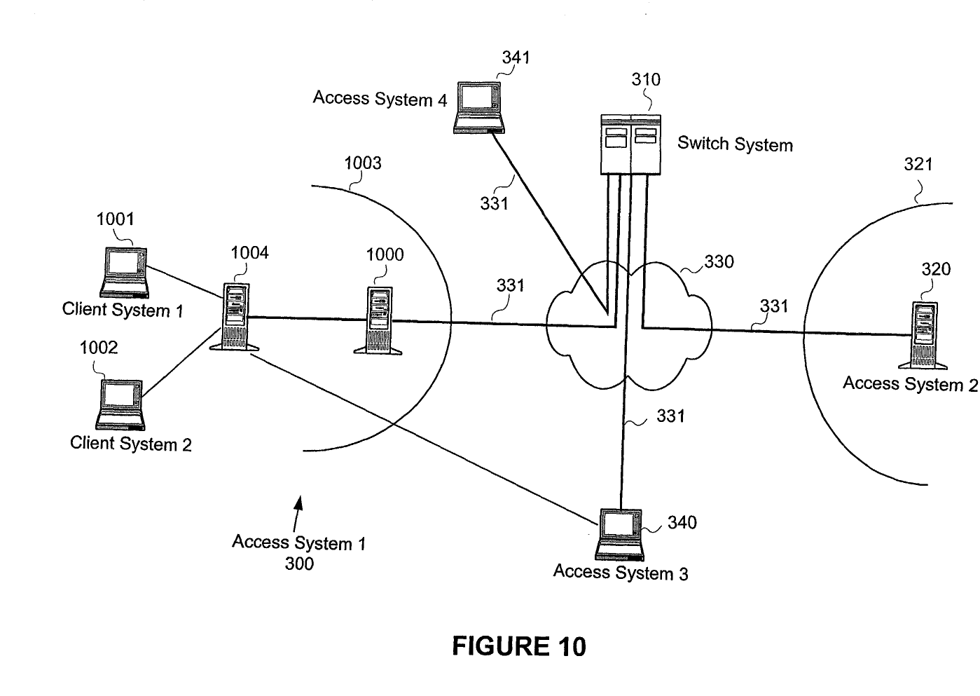

Referring now to FIG. 10, an embodiment of the present invention is depicted wherein an application proxy is utilized as part of an access system. FIG. 10 illustrates a plurality of access systems 300, 320, 340, 341 and a switch system 310 interposed between the access systems. The switch system 310 can connect to each access system via network connections 331, for example, via connections to the Internet 330.

Within network 1003 is an application proxy 1000. The application proxy 1000 provides ease of implementing an access system for network 1003. The application proxy 1000 resides at the edge of the network 1003 and transparently implements the secure network connection. Thus, the application proxy 1000 directs certain network traffic of a particular application through the switch system 310 via a cryptographically secure connection, and transparently decrypts incoming data received from the switch system 310 and redirects the decrypted data to the application 1004. FIG. 10 depicts a separate network application server 1004. However, the application could reside on the client system 1001, 1002 rather than in a separate network application server 1004 as depicted. FIG. 10 also depicts cases in which data transmissions do not utilize the present invention. For example, if access system 340 transmits data from an application different than the application for which the application proxy is configured, that data is transmitted through the network directly to the network application 1004. The data may by-pass the application proxy 1000, as depicted. Alternatively, the application proxy 1000 could receive the data transmission but passes it through to the network application 1004. These embodiments allow for ease of setup since existing applications can use the present invention without any changes being required to the application.

An example of an application proxy includes an email application proxy that redirects all outgoing SMTP (Simple Mail Transfer Protocol) traffic to the switch system 310 for delivery, and then translates all incoming traffic from the switch system 310 prior to it being routed to internal email. Another example of an application proxy is an XML (Extensible Markup Language) application proxy, which redirects all outgoing XML files for secure delivery, and then translates all incoming secure traffic to the XML proxy for decryption and forwarding. A third example of an application proxy is an e-commerce transaction application proxy, which redirects all transactions to the switch system for secure delivery (and tracking, if utilized), and then redirects all incoming traffic received from the switch system 310 to the e-commerce proxy. In yet another example, a network system employs a HTTP (Hypertext Transfer Protocol) application proxy wherein all browser traffic is routed to the proxy, through the switch system and then to the web site server. All data transfer from the web site server is then routed through the switch system, to the application proxy, and then to the end user system 1001, 1002 in the network system.

The application proxies 1000 can be policy based. Thus, certain network traffic will be redirected by the application proxy 1000 for secure transmission if it meets certain policies. Application type (SMTP, HTTP, XML), importance of the data being transmitted (sensitive data), and recipient and/or originator of the data transmission are some examples of the policies that could define which data transmissions are directed to the application proxy in order to utilize the present invention.

The application proxies 1000 can be either client based or server based. For example, the application proxy could be implemented at an access system 300 as depicted in FIG. 10. Alternatively, the application proxy could be implemented by the switch system 310 or on end-user desktop applications.

Additional embodiments could include additional functionality. Thus, the ability to provide secure data transmission could be implemented with applications that provide a service to the users. For example, a secure connection enabled application could include secure email, financial data transfers, data conversions, and the like. Any applications that require the transfer of data between two or more users could utilize the present invention. Through APIs or an application proxy, the present invention could transparently provide secure transfer of the data for the application. Alternatively, a secure-connection enabled application could be accessible to a user via a browser application or through an application on the users local computer or local network.

As depicted in FIG. 11, it shall be also understood that the switch system can be a single independent node or can be configured to include multiple nodes that are securely interconnected. It shall also be understood that references to switch system 310 include both single-node and multi-node configurations. FIG. 11 illustrates multiple nodes 310A-310C securely networked together by a secure interconnection 1120.

In a multi-node configuration, one access system 300 may connect to one node 310A, and another access system 320 may connect to another node 310C. In one embodiment, data 400 from access system 300 is sent through a secure connection to node 310A, which then routes the data to node 310C, which eventually routes the mail through secure connection to access system 320. In another embodiment, access system 300 sends data 400 through a secure connection to node 310A; the data 400 however remains at node 310A. When access system 320 connects to node 310C, it is then redirected to pick up the data 400 at node 310A.

As the number of access systems (i.e., the client base) increases, multiple nodes can distribute the tasks of the present invention to better serve the users. In addition to distributing the functions and steps of the present invention, the multi-node configuration allows for redundancy. For example, an access system can connect to more than one switch system node for redundancy and any data transmission from that access system may be sent along concurrent paths through interconnecting switch system nodes to the intended recipient access system. Furthermore, the multiple switch system nodes could also provide redundancy coverage for each other. For convenience, throughout this specification any reference to a switch system shall be read to include both single-node and multiple-node configurations.

From the above description, it will be apparent that the invention disclosed herein provides a novel and advantageous system and method of securely transmitting data between to access systems.

The above description is included to illustrate the operation of the preferred embodiments and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. A computer-implemented method for creating a cryptographically secure network between at least two access systems, the method comprising a switch system performing the steps of:
associating each of a plurality of access systems with a public key from a private-public key pair associated with said access system;
in response to a request from a first access system to transmit data to a second access system:
authenticating the first access system using the public key associated with the first access system;
forming a first cryptographically secure network connection between the authenticated first access system and the switch system;
accepting data from the authenticated first access system via the first cryptographically secure network connection;
authenticating the second access system using the public key associated with the second access system;
forming a second cryptographically secure network connection between the authenticated second access system and the switch system; and
transmitting the data to the authenticated second access system via the second cryptographically secure network connection.

2. The method of claim 1 wherein the switch system issues to an access system the access system's private-pubic key pair.

3. The method of claim 1 wherein the switch system comprises a plurality of nodes securely networked together.

4. The method of claim 2 wherein the first and second access systems connect to the switch system via different nodes.

5. The method of claim 1 further comprising the switch system performing the step of:
using a switch system private key, in conjunction with an access system using a corresponding switch system public key, to authenticate the switch system to the access system.

6. The method of claim 1 wherein the first and second cryptographically secure connections are each implemented by encrypting the data at a layer selected from the group comprising an application layer, a presentation layer, and a session layer of the Open Systems Interconnection reference model.

7. The method of claim 6 wherein the first and second cryptographically secure network connections are each formed using at least one encryption key from a group comprising a symmetric key, an asymmetric key, and a symmetric session key encrypted with an asymmetric key.

8. The method of claim 1 wherein the data is encrypted with at least one encryption key for which the switch system does not have access to the encryption key's corresponding decryption key.

9. The method of claim 1 wherein the data comprises at least one from the group comprising:
a digest of at least a portion of the data; and
a digital signature of the first access system.

10. The method of claim 1 further comprising the switch system performing the step of storing at least one of the group comprising the data, a digest of at least a portion of the data, and a digital signature.

11. The method of claim 10 further comprising the switch system performing the step of time-stamping at least one of the group comprising the data, a digest of at least a portion of the data, and a digital signature of the first access system.

12. The method of claim 1 wherein the switch system interfaces with an application which utilizes the data exchanged between the first and second access systems.

13. The method of claim 1 wherein at least one of the first and second access systems connects to the switch system via an application proxy.

14. The method of claim 13 wherein the application proxy processes data initiated from an access system and data intended for the access system based upon predefined policies.

15. The method of claim 14 wherein the policies for the application proxy are set by the access system.

16. A switch system for establishing a secure network connection between at least two access systems, the switch system comprising:
at least one node comprising:
a key module for associating each access system with a public key from a private-public key pair associated with said access system;
an authentication module, coupled to the key manager module, for using an access system's public key, in conjunction with the access system using its private key, to authenticate the access system; and
a secure network module, coupled to the authentication module, for establishing a cryptographically secure network connection between the switch system and an authenticated access system, whereby data is received from a first access system via a first secure connection and transmitted to a second access system via a second secure connection.

17. The system of claim 16 wherein the key module is further adapted to perform the step of:
issuing a private-public key pair to an access system.

18. The system of claim 16 wherein the authentication module is further adapted to perform the step of:
using a switch system private key, in conjunction with an access system using a corresponding switch system public key, to authenticate the switch system to the access system.

19. The system of claim 16 wherein the cryptographically secure network connection is implemented by encrypting the data at a layer selected from the group comprising an application layer, a presentation layer, and a session layer of the Open Systems Interconnection reference model.

20. The system of claim 19 wherein the cryptographically secure network connections are formed using at least one encryption key from the group comprising a symmetric key, an asymmetric key, and a symmetric session key encrypted with an asymmetric key.

21. The system of claim 16 wherein the data is encrypted with at least one encryption key for which the switch system does not have access to the encryption key's corresponding decryption key.

22. The system of claim 16 wherein the node further comprises:
a computer-readable medium for storing at least one of the group comprising the data, a digest of at least a portion of the data, and a digital signature of an access system.

23. The system of claim 16 wherein the node further comprises:
a tracking module for time-stamping and storing at least one of the group comprising the data, a digest of at least a portion of the data, and a digital signature of an access system.

24. The system of claim 16 wherein the node further comprises:
an interface module for interfacing with a network application to provide a service in conjunction with the data transferred via the switch system.

25. The system of claim 16 further comprising a plurality of nodes securely networked together.

26. The system of claim 16 further comprising:
an application proxy for processing the data initiated from an access system and data intended for the access system based upon predefined policies.

27. An access system for establishing a cryptographically secure connection to a switch system, the access system comprising:
a key module for accessing a private-public key pair of a user of the access system;
an authentication module, coupled to the key module, for authenticating to the switch system using the private-public key pair; and
a secure network connection module, coupled to the authentication module, for establishing a cryptographically secure connection between the switch system and the access system, wherein data is transmitted to and received data from the switch system via the cryptographically secure connection.

28. The system of claim 27 wherein the key module is further adapted to perform the step of:
generating a private-public key pair for the user.

29. The system of claim 27 wherein the authentication module is further adapted to perform the step of:
using a switch system public key, in conjunction with the switch system using a corresponding switch system private key, to authenticate the switch system to the access system.

30. The system of claim 27 wherein the cryptographically secure network connection is implemented by encrypting the data at a layer selected from the group comprising an application layer, a presentation layer, and a session layer of the Open Systems Interconnect reference model.

31. The system of claim 30 wherein the cryptographically secure network connections are formed using at least one encryption key from the group comprising a symmetric key, an asymmetric key, and a symmetric session key encrypted with an asymmetric key.

32. The system of claim 27 wherein the data is encrypted with at least one encryption key for which the switch system does not have access to the encryption key's corresponding decryption key.

33. The system of claim 27 wherein the secure network connection module is further adapted for generating at least one of the group comprising a digest of at least a portion of the data and a digital signature of the access system.

34. The system of claim 27 wherein the access system is implemented in a secure-network-connection application proxy.

35. The system of claim 34 wherein the secure-network-connection application proxy is accessed by more than one client system.

36. The system of claim 34 wherein the secure-network-connection application proxy processes data initiated from a client system and data intended for the client system based upon predefined policies.

37. The system of claim 27 wherein the access system is implemented in a secure-network-connection enabled application.

38. The system of claim 27 wherein the access system is implemented through a set of application program interfaces.

39. In a computer-readable medium, a computer program product for creating a cryptographically secure network between at least two access systems, the computer-readable medium comprising program code adapted to perform the steps of:
associating each of a plurality of access systems with a public key from a private-public key pair associated with said access system;
in response to a request from a first access system to transmit data to a second access system:
authenticating the first access system using the public key associated with the first access system;
forming a first cryptographically secure network connection between the authenticated first access system and the switch system;
accepting data from the authenticated first access system via the first cryptographically secure network connection;
authenticating the second access system using the public key associated with the second access system;
forming a second cryptographically secure network connection between the authenticated second access system and the switch system; and
transmitting the data to the authenticated second access system via the second cryptographically secure network connection.

40. The computer readable medium of claim 39 wherein the switch system issues to an access system the access system's private-pubic key pair.

41. The computer readable medium of claim 39 wherein the switch system comprises a plurality of nodes securely networked together.

42. The computer readable medium of claim 41 wherein the first and second access systems connect to the switch system via different nodes.

43. The computer readable medium of claim 39 farther comprising program code adapted to perform the step of:
using a switch system private key, in conjunction with an access system using a corresponding switch system public key, to authenticate the switch system to the access system.

44. The computer readable medium of claim 39 wherein the first and second cryptographically secure connections are each implemented by encrypting the data at a layer selected from the group comprising an application layer, a presentation layer, and a session layer of the Open Systems Interconnection reference model.

45. The computer readable medium of claim 44 wherein the first and second cryptographically secure network connections are each formed using at least one encryption key from the group comprising a symmetric key, an asymmetric key, and a symmetric session key encrypted with an asymmetric key.

46. The computer readable medium of claim 39 wherein the data is encrypted with at least one encryption key for which the switch system does not have access to the encryption key's corresponding decryption key.

47. The computer readable medium of claim 39 wherein the data further comprises at least one from the group comprising:
a digest of at least a portion of the data; and
a digital signature of the first access system.

48. The computer readable medium of claim 39 further comprising program code adapted to perform the step of:
storing at least one of the group comprising the data, a digest of at least a portion of the data, and a digital signature.

49. The computer readable medium of claim 48 further comprising program code adapted to perform the step of:
time-stamping at least one of the group comprising the data, a digest of at least a portion of the data, and a digital signature of the first access system.

50. The computer readable medium of claim 39 wherein the switch system interfaces with an application which utilizes the data exchanged between the first and second access Systems.

51. The computer readable medium of claim 39 wherein at least one of the first and second access systems connects to the switch system via an application proxy.

52. The computer readable medium of claim 51 wherein the application proxy processes data initiated from an access system and data intended for the access system based upon predefined policies.

53. The computer readable medium of claim 52 wherein the policies for the application proxy are set by the access system.
